(19) United States
(12) Patent Application Publication
(10) Pub. No.: US 2012/0093564 A1
(43) Pub. Date: Apr. 19, 2012

(54) METHOD FOR THE PRODUCTION OF A PAPER PEN/PENCIL

(76) Inventor: Karl-Heinz Bosch, La Orotava (ES)

(21) Appl. No.: 13/147,009

(22) PCT Filed: Feb. 8, 2010
(86) PCT No.: PCT/EP10/00765

§ 371 Date: Dec. 16, 2011

(30) Foreign Application Priority Data
Feb. 11, 2009 (DE) 10 2009 008 411.8
Mar. 6, 2009 (DE) 10 2009 011 554.4
Apr. 22, 2009 (DE) 10 2009 018 304.3
Dec. 4, 2009 (DE) 10 2009 056 811.5

(51) Int. Cl. B43K 19/14; B23P 11/00; B29C 65/48; B43K 29/12

(52) U.S. Cl. 401/52; 29/428; 401/88; 156/297

(57) ABSTRACT

In a method for producing a paper pen/pencil (19), the following steps are carried out: a lead/reservoir (12) is introduced into a receptacle (14, 21, 23, 28, 29, 34, 38); the lead/reservoir (12) is secured within the receptacle (14, 21, 23, 28, 29, 34, 38); and the receptacle (14, 21, 23, 28, 29, 34, 38) is connected to paper (1).

### FIELD OF THE INVENTION

This invention is generally related to a method for manufacturing a paper writing utensil.

### BACKGROUND OF THE INVENTION

If one wishes to quickly jot down a note, one needs a piece of paper and a writing utensil. A few pieces of paper may be carried in a wallet or in a pant pocket. However, the paper bends if one sits down with the wallet in a back pocket of his pants. Moreover, a writing utensil, such as a ballpoint pen or a pencil, is awkward to carry in a pocket. Pens or pencils are hard and may cause discomfort, as they do not adjust to movements. They can snap if one sits down on them, or they can hurt the person carrying them. Apart from these disadvantages, one always needs to remember two items—paper and a writing utensil—to be ready for quick note taking.

### SUMMARY OF THE INVENTION

It is an objective of the hereby presented invention to eliminate these disadvantages and to create a possibility to take written notes at any time, without the need for carrying a writing utensil.

The objective is reached by the features of the claimed process for manufacturing a paper writing utensil and the associated writing utensil and receptacle therefor.

In a device in accordance with the invention, a flexible writing utensil is incorporated into a piece of paper. Consequently, only the paper or a note pad consisting of a number of pieces of paper needs to be carried, as the writing utensil is incorporated into the paper and is ready for use. In this embodiment, the “writing utensil” may be a lead or a writing fluid.

Suitably, paper is employed for the taking of notes. Alternatively, other materials may be employed to manufacture a note taking space and/or a writing utensil area. Such materials are, for example: plastic, starch, textiles and/or composite materials.

A piece of paper in accordance with the invention has, near its edge, a perforation by which a strip of the paper may conveniently be torn off by hand. In the embodiment with a writing fluid, a reservoir containing the writing fluid is incorporated into the strip of material. In the embodiment with a lead, a relatively short piece of a pencil lead or a crayon lead is inserted into the strip of material. The length of the lead is chosen to suffice for note taking on a short notice, without, however, causing discomfort in a pant pocket or breaking.

In addition, this strip of material has a further perforation along its length, by which the strip of material may be folded at an angle. In this manner, the strip of material may be formed into a stable, angular writing utensil. Due to the angular cross section extending lengthwise, the paper angle is sufficiently stable that it may be comfortably held in a hand without bending.

In an embodiment with writing fluid, a further perforation at a tip of the paper angle may be torn off such that the ink may flow. In this simple manner, the material strip folded to an angle may be employed to write down a note on the remaining note taking space. A valve in a form of a flow membrane incorporated into the strip of material guarantees a steady flow of the writing fluid.

Business cards are especially suitable for the device in accordance with the invention to be attached. Business cards are made from a relatively stable material, thus giving a greater stability to the angular paper strip and enabling the ink tank or the lead to be completely incorporated into the paper.

In a preferred embodiment, the ink tank is filled with a transparent and/or colorless fluid which only takes on color, or respectively, forms a contrast to the color of the writing space, after making contact with the writing space. To this end, a substance that causes a color change reaction of the writing medium may be added to the material of the writing space.

In this simple manner, a writing utensil may be incorporated also into every sheet of well-known self-adhering note pads.

After the note has been written down on the paper, the folded paper writing utensil containing a writing fluid can easily be folded at the tip to stop the flow of ink. In this manner, the paper may easily be disposed of in a waste paper basket.

The ink may be any medium that fulfills the requirements of the invention.

The invention shall also include an embodiment of the device, according to the invention, as a Post-It® block or as a business card design.

In a further embodiment of the invention, a material strip and a receptacle constitute a flat strip. Preferably, the receptacle is attached to the material strip. A very thin configuration of the receptacle is especially preferred, so that the paper of the writing utensil area and the receptacle add up to a total maximum thickness of 3 mm. Preferably the receptacle is designed in such a manner that the total thickness of the paper and the receptacle, in the unfolded state, amounts to less than 2 mm. Even more preferably, the receptacle is configured in such a manner that the total thickness of the receptacle and the paper amounts to less than 1.5 mm.

Preferably, the receptacle is made of plastic. However, other materials, such as thick carton or the like, may also suitably be employed in the manufacturing of the receptacle.

Suitably, a lead is included in the receptacle. Preferably, the lead takes the form of a pencil lead, a crayon lead or a ball pen reservoir. A very short configuration of the lead is especially preferred. This gives the advantage that the lead does not break as easily.

It should be possible to manufacture the note writing area as a business card.

In a further embodiment the receptacle is preferably designed in such a way that the lead is independently clamped in the receptacle. Hereto the receptacle preferably has openings, strips or a square. More preferably, the openings have a chamfer in order to facilitate insertion of the lead into the opening of the receptacle.

In a further embodiment, the receptacle may have at least one drilled hole in its middle part. This gives the advantage of a better handling.

In a further preferred embodiment of the invention, the receptacle is designed to consist of two parts. Preferably, the receptacle contains an upper part and a lower part. Between the upper and the lower parts, paper is expediently inserted. Especially preferable, the upper and the lower parts are attached to each other and/or to the paper by form-fitted or force-fitted connections, such as engaging cams or gluing.

Expediently, the receptacles themselves are configured to be relatively flexible, so that they remain flexible in areas in which no lead is inserted. This gives the advantage that the receptacles themselves do not break under strain due to, for example, pressure in a pant pocket.

Suitably, where the receptacles have cams, the main body of the receptacle will be made larger than the cams and the perforations in the paper, so as to cover the perforations. This advantageously results in a better optical effect.

Also preferred in a further embodiment of the receptacles, short, ink-filled capillary tubes are inserted into the receptacle, instead of pencil leads. A further alternative is to incorporate small, short ball pen reservoirs into the receptacle.

In an especially preferred embodiment of the invention, the paper has on its backside, a layer of resoluble pressure-sensitive adhesive. Even more preferred is a number of sheets being bound together as a pad, with pressure-sensitive adhesive, such as Post-It® or sticky-note pads.

Expediently, the application of force when writing is applied to the lead in such a manner that the force is absorbed by the whole paper writing utensil.

In a further preferred embodiment of the invention, the receptacle is formed by a drop of synthetic resin, which is applied to the paper, and into which the lead is inserted. Also included within the scope of the idea of the invention is positioning the lead on the paper, and then fixating it with a drop of synthetic resin.

In a further embodiment of the invention, a very short lead is attached to the flat strip, or the paper, via two layers of laminate.

In a further preferred embodiment, a synthetic material resembling, for example, a credit card, is employed, rather than paper. This piece of material has an opening,. into which the lead is directly inserted.

Apart from the above, a method for the manufacturing of a paper writing utensil is also claimed. Preferably, the receptacle is manufactured as an injection molding part. Suitably, the lead is directly insert molded, while the receptacle is injected. Also preferred is to insert the lead into the receptacle only after the receptacle has hardened. If required, the lead is shortened to the right length after it has been inserted into the receptacle. The paper or the corresponding medium employed, is imprinted and cut to size. Subsequently, the receptacle is attached to the paper. For this method, the following connection types are provided: gluing, thermal forming, clipping, and/or inserting.

In a method for producing the paper writing utensil, the following steps are to be taken: the insertion of the lead into the receptacle, the fixating of the lead in the receptacle and the attachment of the receptacle to the paper. The order of these steps is not fixed. Preferably, before the receptacle is attached to the paper, the latter is cut into a desired form and imprinted. This sequence gives the advantage that the lead, and respectively the receptacle, are not damaged during the printing and cutting processes and do not constitute disruptive bodies.

Especially when having a small number of paper writing utensils, it is possible to imprint the paper on conventional printers and then to glue, weld or clip the receptacle holding the lead onto the ready imprinted and punched card or paper.

Preferably, the lead is clamped to the paper. It is also preferable to fixate the lead in the receptacle by gluing. In a further preferred embodiment, the lead is welded to the receptacle. It is especially preferred to thermally connect the lead to the receptacle.

Suitably, the receptacle has at least one groove into which the paper is inserted. Preferably, the receptacle is agglutinated with the paper.

In a preferred embodiment, the paper and the receptacle are connected through thermal deformation.

Preferably, the paper strip has at least one folding line. The folding line is advantageously an auxiliary feature. For example, the folding line takes the form of a line, a fold, a recess or a perforation.

Suitably, the paper writing utensil has a perforated line for detaching the paper writing utensil from a note taking space. Thus, it is possible to advantageously write on the note taking area with the folded paper writing utensil.

In a preferred embodiment, the note taking space has a resoluble sticking area. Alternatively, the sticking area may be non-resoluble. With that, several single note taking spaces may be joined to some kind of note pad or a Post-It® pad.

Preferably, the paper writing utensil has at least one circumferential groove. Into the groove, the paper may advantageously be inserted and then fixated.

In another preferred embodiment, the paper writing utensil has at least one fastening knob. Particularly preferred is the paper writing utensil having between two and five fastening knobs. Suitably, the paper strip has at least one opening. Preferably, the openings are formed to correspond roughly to a size and a location of the knobs. The fastening knobs are pressed through the openings to secure a connection between the receptacle and the paper. To secure fixation, the knobs may be glued to the paper or they may be formed or caught in another manner.

A receptacle for a paper writing utensil according to the described characteristics is also claimed. Preferably, the receptacle has an opening to receive the lead.

Especially preferable is a configuration in which the receptacle is formed to be maximally 2 mm higher than the paper strip. In a further preferred embodiment, the receptacle has at least one groove for receiving the paper strip. Advantageously, the paper strip may then be clamped, glued or held or fixated in another manner to the grooves.

In another preferred embodiment, the receptacle has fastening knobs. Particularly preferable, the fastening knobs are guided in corresponding recesses in the paper.

In another preferred embodiment, the length of the receptacle equals maximally one half of the length of the paper strip. This advantageously helps ensure that the paper strip in its unfolded state remains flexible and is not damaged, for example, by pressure strain in the pants pocket.

In the method for the production of the paper writing utensil, the order in which the method steps are executed is irrelevant.

In addition, the receptacle is to be configured in such a manner that any device can be executed as a receptacle that is suitable to secure a fixated seat of a lead on a paper.

### BRIEF DESCRIPTION OF THE FIGURES

Further advantages, features and details of the invention follow from the description of preferred embodiments as well as from the drawings, wherein:

FIG. 1 is a top view of a device in accordance with the invention in an unfolded state;

FIG. 2 is an enlarged perspective view of a detached material strip;

FIG. 3 is a further embodiment of a device in accordance with the invention in an unfolded state;

FIG. 4 is a top view of a further embodiment of a device in accordance with the invention meant for writing or drawing with a lead as a writing medium in an unkinked initial state;

FIG. 5 is an enlarged side view of the device meant for writing or drawing with lead in the unkinked initial phase according to FIG. 4;

FIG. 6 is a back view of the device for writing or drawing with a lead in an unfolded initial state;

FIG. 7 is a perspective illustration of a detached and folded writing utensil area of a device for writing or drawing;

FIG. 8 is a side view of the detached and folded writing utensil area according to FIG. 7;

FIG. 9 is a schematic view from below of a further embodiment of a receptacle with welding cams;

FIG. 10 is a schematic side view of an embodiment of the receptacle with welding clamps according to FIG. 9;

FIG. 11 is a schematic top view of the receptacle with welding clamps according to FIG. 9;

FIG. 12 is a schematic drawing in perspective of the receptacle with welding clamps according to FIG. 9;

FIG. 13 is a schematic view from below of a further embodiment of a receptacle with clips;

FIG. 14 is a schematic side view of the receptacle with clips according to FIG. 13;

FIG. 15 is a schematic top view of a further embodiment of a receptacle formed in two parts;

FIG. 16 is a schematic side view of the two-part receptacle according to FIG. 15;

FIG. 17 is a top view of the two-part receptacle according to FIG. 15;

FIG. 18 is a schematic perspective illustration of the two-part receptacle according to FIG. 15;

FIG. 19 is a schematic view from below of a further embodiment of a receptacle with cams;

FIG. 20 is a schematic side view of the receptacle with cams in accordance with FIG. 19;

FIG. 21 is a schematic top view of the receptacle with cams in accordance with FIG. 19;

FIG. 22 is a schematic perspective drawing of the receptacle with cams in accordance with FIG. 19;

FIG. 23 is a schematic view from below of a further embodiment of a receptacle with kink wings;

FIG. 24 is a schematic side view of the receptacle with kink wings in accordance with FIG. 23;

FIG. 25 is a schematic top view of the receptacle with kink wings in accordance with FIG. 23;

FIG. 26 is a perspective illustration of the receptacle with kink wings in accordance with FIG. 23;

FIG. 27 is a schematic side view of a further embodiment of a receptacle with grooves;

FIG. 28 is a schematic perspective illustration of the receptacle with grooves in accordance with FIG. 27;

FIG. 29 is a schematic top view of an unfolded writing utensil area with three kink areas;

FIG. 30 is a schematic side view of a folded writing utensil area with three kink areas;

FIG. 31 is a schematic top view of several writing utensil areas in series, in their unfolded state;

FIG. 32 is a schematic top view of an unfolded writing utensil area with a receptacle made of synthetic resin;

FIG. 33 is a schematic side view of the unfolded writing utensil area in accordance with FIG. 32; and

FIG. 34 is a schematic side view of an unfolded writing utensil area with a receptacle constructed of the same material.

### DETAILED DESCRIPTION

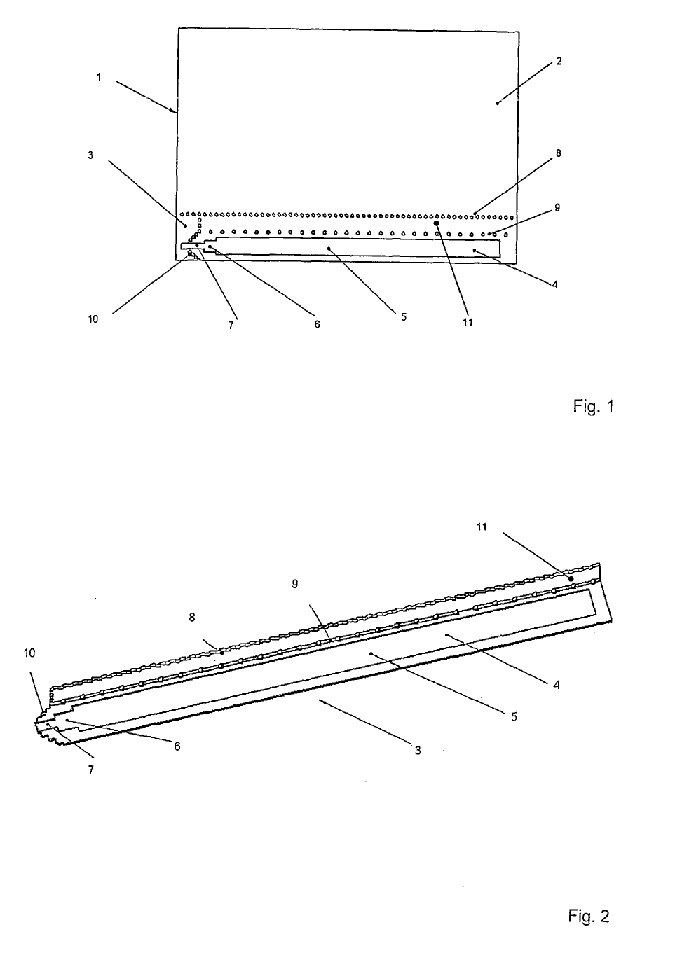

As shown in FIG. 1, the device according to the invention consists of a preferably somewhat thick sheet of paper 1 in an unfolded state, seen from above. The paper 1 is divided into a note taking area 2 and a material strip 3.

The note taking area 2 of the paper 1 has room for writing down notes. The material strip 3 serves as a writing utensil, resembling a felt pen. A flat tank 4 in a form of a thin depression is impressed in the paper of the material strip 3. This depression is lined with a plastic film or is liquid-tight coated. In this tank 4, there is a writing fluid 5 for writing down a note. The tank 4 again is covered with a plastic film on the upper surface and thus forms a tight unit, from which the writing fluid 5 cannot escape. At the front end of the color tank 4, a valve 6 and a narrow channel 7 are included.

Furthermore, several papers 1 may also be joined together to form a note taking pad (not shown). The several papers 1 may be coated on one side with resoluble pressure-sensitive adhesive.

The function of the present invention is as follows:

In order to write down a note on the note taking space 2, one simply detaches the material strip 3 from the note taking space 2 by tearing the paper 1 apart at the perforation 8. Then, one folds the material strip 3 at the perforation 9 upwards so that the material strip 3, seen from the front side, acquires an L-shaped profile.

FIG. 2 shows the material strip 3 torn off from the note taking space 2 in a perspective view. Here, the material strip 3 is already folded at the perforation 9 to form an L-shaped profile.

Due to this profile, the material strip 3, while basically consisting of paper, acquires an inherent stable form that helps prevent bending or breaking. Now, the tip of the material strip 3 is detached at the perforation 10. By this step of detaching, the narrow channel 7 of the tank 4, being incorporated in the material strip 3 opens. Meanwhile, the perforation 10 is formed in such a manner that the material strip 3 acquires a tipped form, similar to a writing utensil. Now, when material strip 3 prepared in this manner is held vertically, the ink 5 can flow out of the tank 4, through the channel 7, outwards and with this ink a note may be written on the note taking space 2. The incorporated valve 6 controls here the flow of ink in such a manner that a steady writing without dripping is guaranteed. When the writing process is completed, the material strip 3 may simply be folded at the tip, so that a further flow of ink is prevented and the material strip 3 may tidily be disposed of in a waste paper basket.

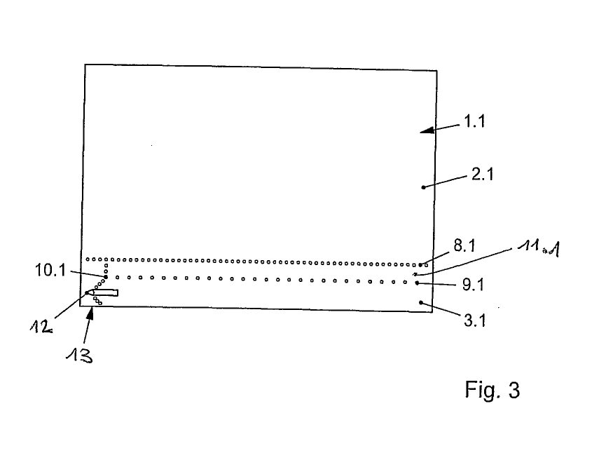

FIG. 3 shows a further embodiment of a device in accordance with the invention. This embodiment has a lead 12 for writing. Analogous to the previous embodiment, a paper 1.1 is also built from a note taking space 2.1 and a writing utensil area 3.1. This writing utensil area 3.1 can be detached at a perforation 8.1 from the note taking area and folded at the perforation 9.1, thus adding stability. The writing utensil area 3.1 is, at least in its front area 13, divisible, in order to receive the pencil lead 12. In this configuration, the pencil lead 12 is formed to a length that prevents awkwardness in a pant pocket or breaking. This length normally suffices for writing on a piece of paper in the size of the note taking space 2.1. In order to free the lead 12, the front area 13 is detached at a perforation 10.1, analogous to the embodiment with writing fluid. Alternatively, the lead 12 may protrude from the writing utensil area 3 for immediate use, or the front area 13 may be folded down or apart.

Naturally, the invention also includes in its scope the use of a colored lead or the like.

Preferably, the length of the pencil lead is between 2 mm and 15 mm, since such a length has proven especially break-proof, and a lead of 2 mm length suffices to write on a space the size of a business card.

FIGS. 4 to 8 reveal a further embodiment of a device in accordance with the invention for writing, drawing or the like. Analogous to the embodiments described above, the paper 1.2, too, has a note taking space 2.2 and a writing utensil area 3.2. Between the note taking space 2.2 and the writing utensil area 3.2, the paper 1.2 has a perforated line 8.2.

The writing utensil 3.2 contains two kink areas 11.2 and 11.3. The kink areas are separated from a receptacle area 20 by folding lines 16.1 and 16.2, respectively. In a front area 13, two further perforation lines 10.2 and 10.3 are provided. These perforation lines 10.2 and 10.3 extend from the edges of the writing utensil area 3.2 towards an opening 15, which is provided adjacent the front area 13 in the writing utensil area 3.2.

Also adjacent the front area 13, a receptacle 14 is provided on the writing utensil area 3.2 between the two kink areas 11.2 and 11.3. The receptacle 14 is very flat (≦2 mm) The receptacle 14 has a length L, which equals, at most, half of a length K of the writing utensil area 3.2 or the paper strip. Especially preferred is a configuration in which the receptacle 14 is made of plastic.

To further advantage, the receptacle 14 is formed to be very thin. Thus, the overall thickness of the paper 1 of the writing utensil area 3 and the receptacle 14 is a maximum of 2 mm. Preferably, the receptacle 14 is formed in such a manner that the total thickness of paper 1 and receptacle 14 in their unfolded state equals less than 2 mm. Even more preferred is a design by which the receptacle 14 is formed such that the total thickness of receptacle 14 and paper 1 is less than 1.5 mm.

In another preferred embodiment, the receptacle 14 is formed in such a manner that it has a maximum height (h) 2 mm higher than the paper strip.

A lead 12 is received in the receptacle 14. The lead 12 is configured as a pencil lead.

In further embodiments the lead is preferably configured as a crayon lead or a ball pen reservoir.

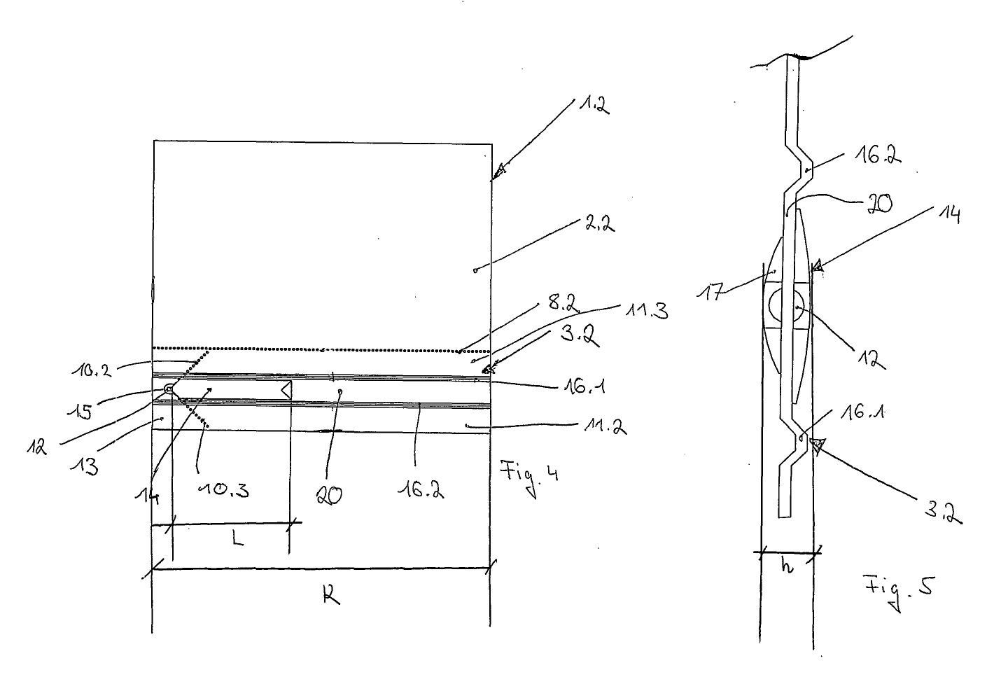

The lead 12 extends into the opening 15. The receptacle 14 has a pin 17, as shown in FIGS. 5 and 6. This pin 17 grips in or through an opening 18 of the writing utensil area 3.2. Thus, the receptacle 14 is fixed to the writing utensil area 3.2. Preferably, the receptacle 14 is additionally glued to the writing utensil area 3.2, specifically to the receptacle area 20 of the writing utensil area 3.2.

The material strip 3 consists of at least two layers. Between the layers lies the tank 4 or the receptacle 14.

The writing fluid 5 being in the tank 4 has a fluid, jelly-like or powdery consistency.

Besides, the note taking area 2 has such a paper thickness that the tank 4 may be incorporated completely into a paper 1 via imprinting.

The function of the present embodiment is as follows:

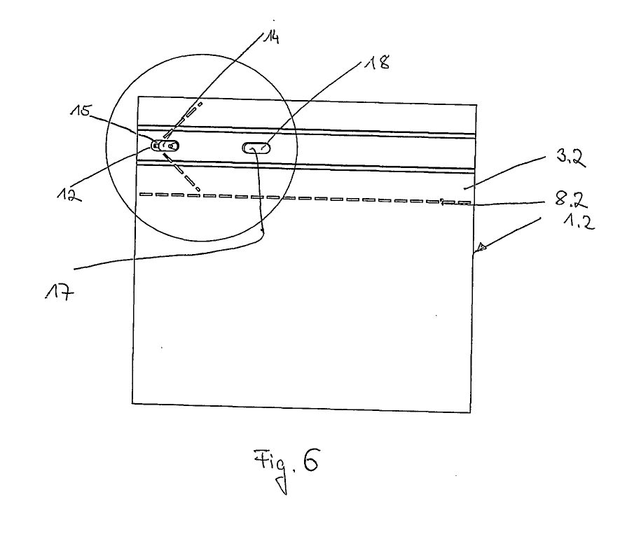

The writing utensil area 3.2 is detached from the note taking space 1.2 over the perforation line 8.2. Then the front area 13 is detached along the perforation lines 10.2 and 10.3, in order to free the lead 12. Subsequently and as shown in FIGS. 7 and 8, the kink areas 11.2 and 11.3 are folded along the folding lines 16.1 and 16.2 and bent back so that a writing utensil 19 is formed. With this writing utensil 19, writing or drawing on the note taking space 2.2 or on another medium becomes possible.

In further preferred embodiments, receptacles for paper writing utensils may have the following features:

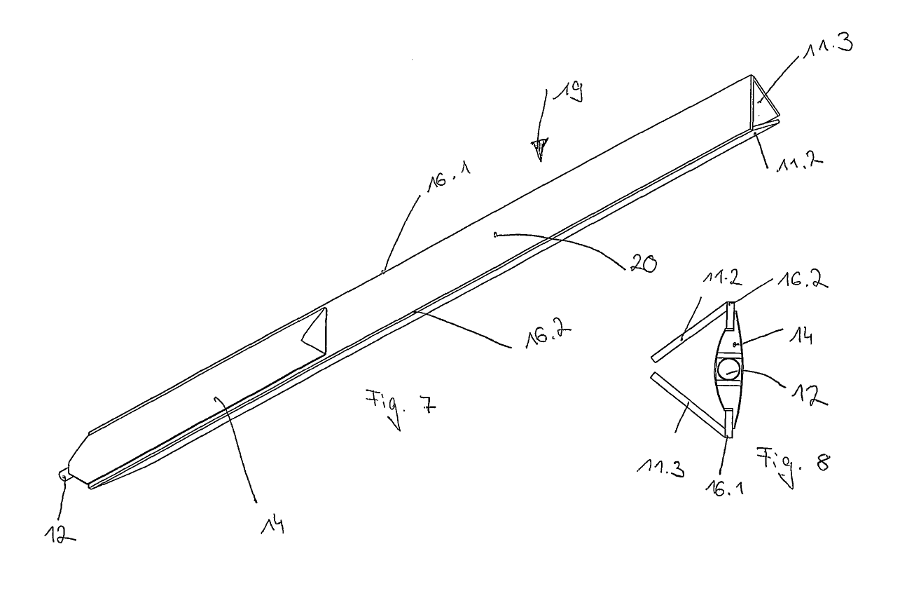

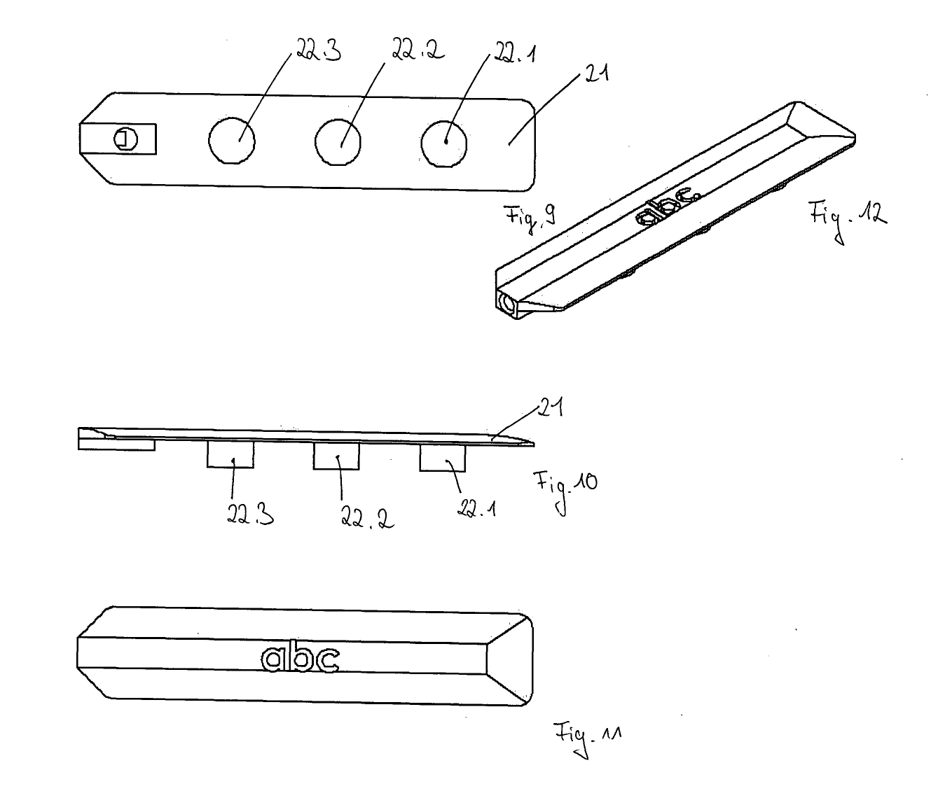

FIGS. 9 to 12 disclose a receptacle 21 with welding cams 22.1, 22.2 and 22.3. For connecting with the paper strip not shown), the paper strip has openings roughly in the size of the welding cams 22.1 to 22.3 and in their arrangement. Then, the welding cams 22.1 to 22.3 are guided through the corresponding openings and welded to the paper, and are deformed so that they hold the paper.

FIGS. 13 and 14 reveal a further preferred embodiment of a receptacle 23. The receptacle 23 has three clips 24.1 to 24.3. Each one of the clips 24.1 to 24.3 has a neck 25. To the neck 25 a collar 26 follows. The collar 26 has a larger diameter than the neck 25. The collar 26 also has a chamfer 27 to facilitate the insertion of the clips 24.1 to 24.3 into the openings of the paper. The openings in the paper have a diameter corresponding to the size of the collar 26 and the arrangement of the clips 24.1 to 24.3, such that the clips 24.1 to 24.3 held in the openings by the collars 26.

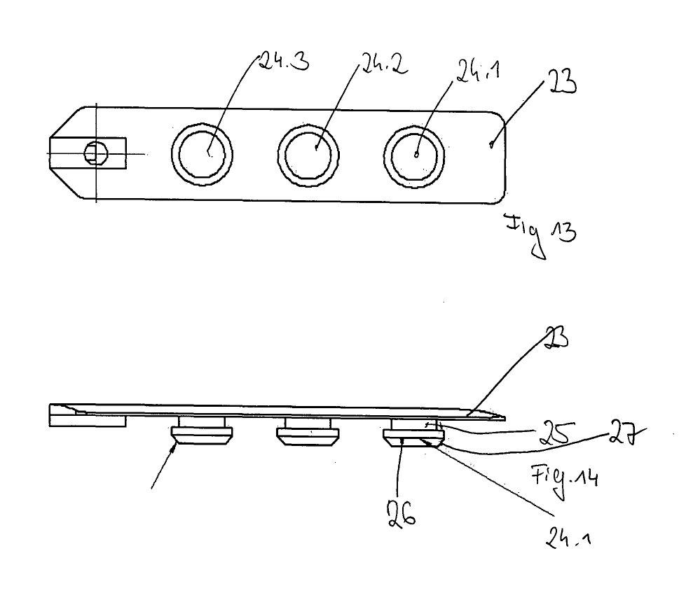

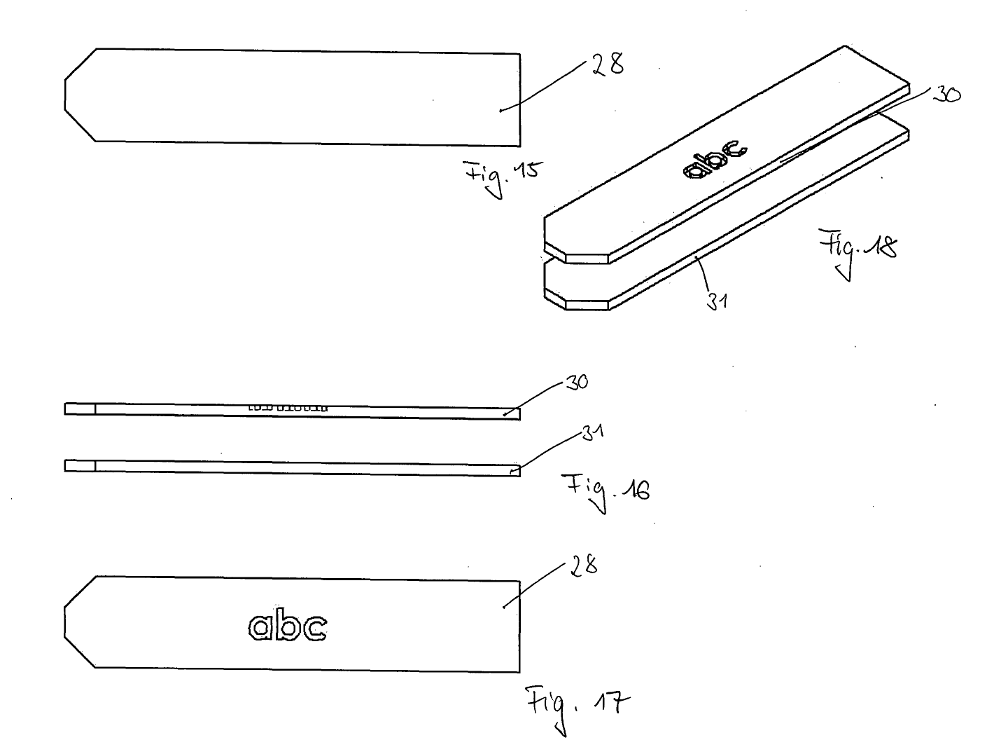

FIGS. 15 to 18 reveal a further preferred embodiment of a receptacle 28. The receptacle 28 is formed of two parts. The receptacle 28 has an upper part 30 and a lower part 31, as shown in FIG. 16, between which the paper is inserted. To fix the paper to the upper part 30 and the lower part 31, the receptacle 28 is preferably glued to the paper or deformed. Preferably, the receptacle 28 is thermally deformed thereto.

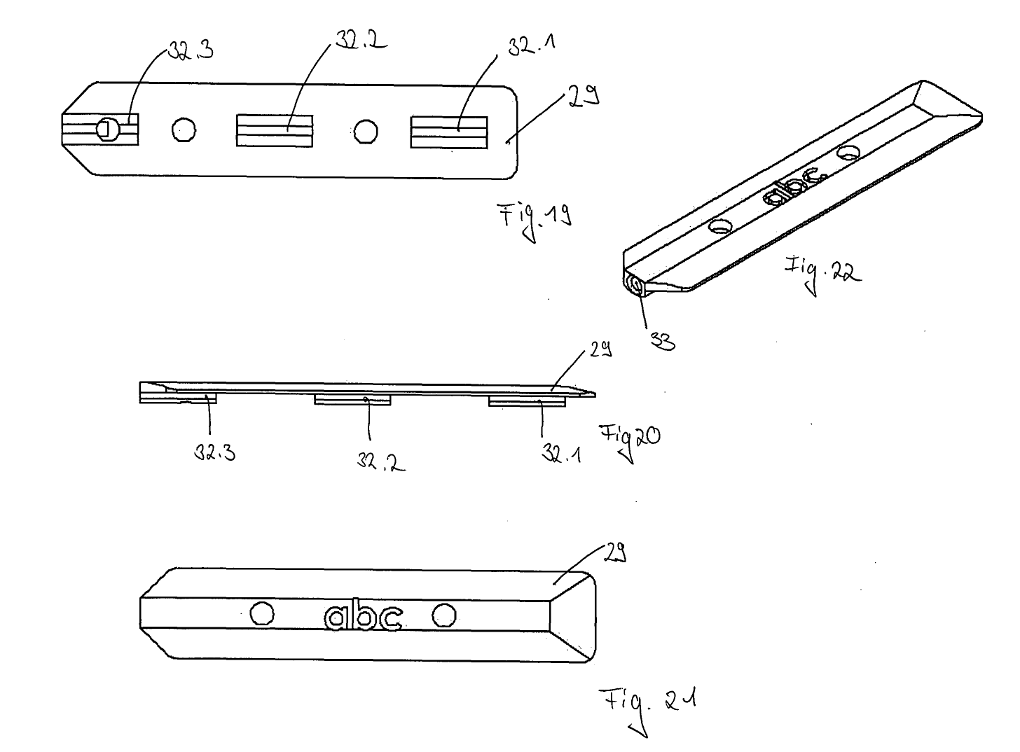

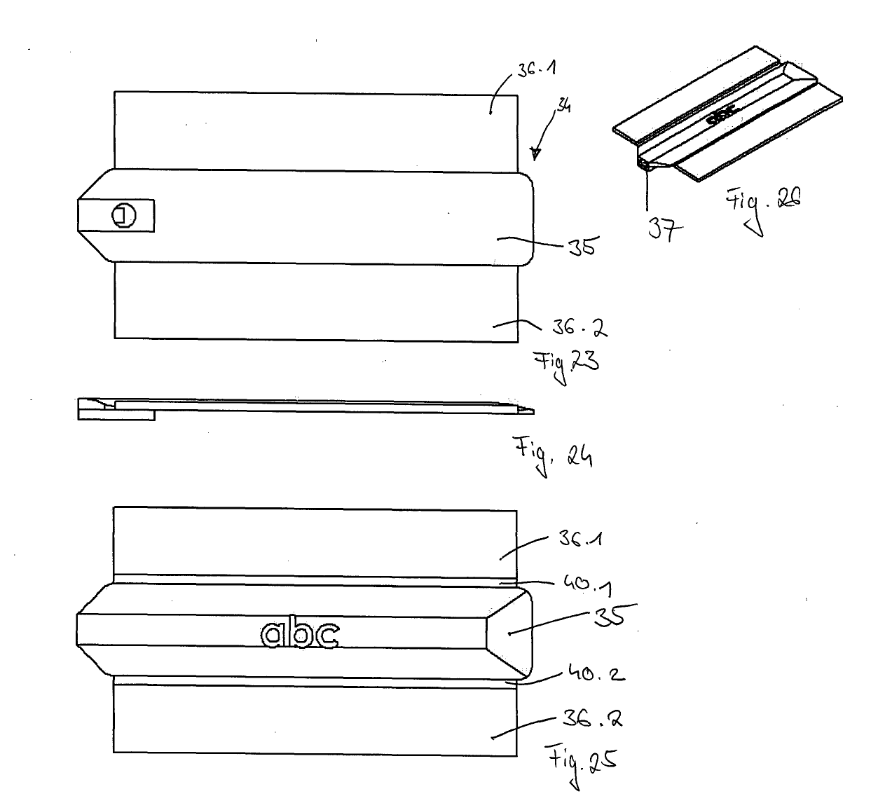

FIGS. 19 to 22 disclose a further embodiment of a receptacle 29 with cams 32.1 to 32.3. The cams 32.1 to 32.3 are formed as rectangles. In order to connect the receptacle 29 with the paper, the cams 32.1 to 32.3 are guided into openings in the paper. To ensure fixation, the cams 3.21 to 32.3 are then glued, deformed and/or ironed. The receptacle 29 has an opening 33 into which a lead may be inserted.

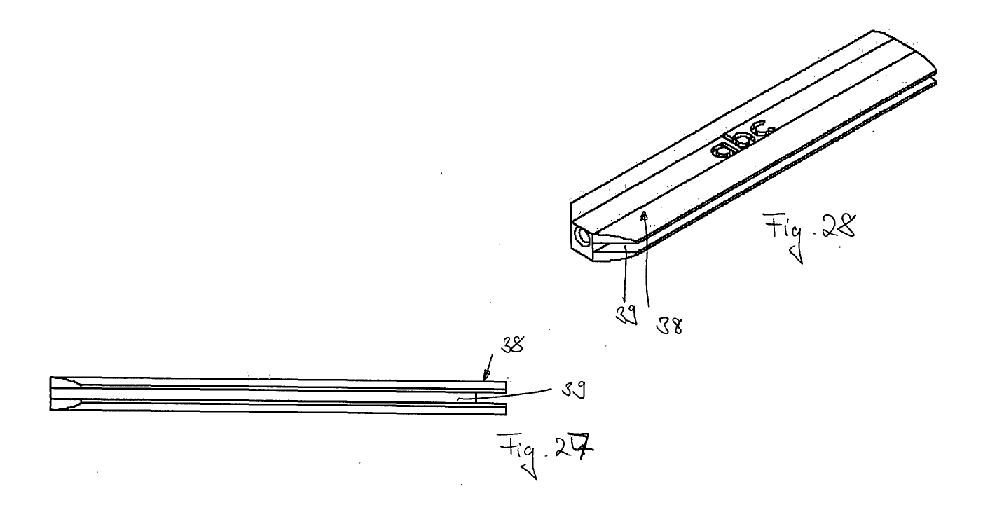

FIGS. 23 to 26 reveal a further preferred embodiment of a receptacle 34. The receptacle 34 has a main body 35 to which two kink wings 36.1 and 36.2 are formed. The main body 35 of the receptacle 34 has an opening 37 to receive a lead. The kink wings 36.1 and 36.2 may be connected to the paper. Preferably, adhesive is used to connect the paper with the folding wings 36.1 and 36.2. Areas 40.1 and 40.2, between the kink wings 36.1 and 36.2 and the main body 35 of the receptacle 34, are formed to be very thin, in order to allow an easy folding and bending of the kink wings 36.1 and 36.2 from the main body 35.

In a further embodiment, which is not shown, several of these receptacles may be strung together so that they may be, for example, torn off from each other to allow writing.

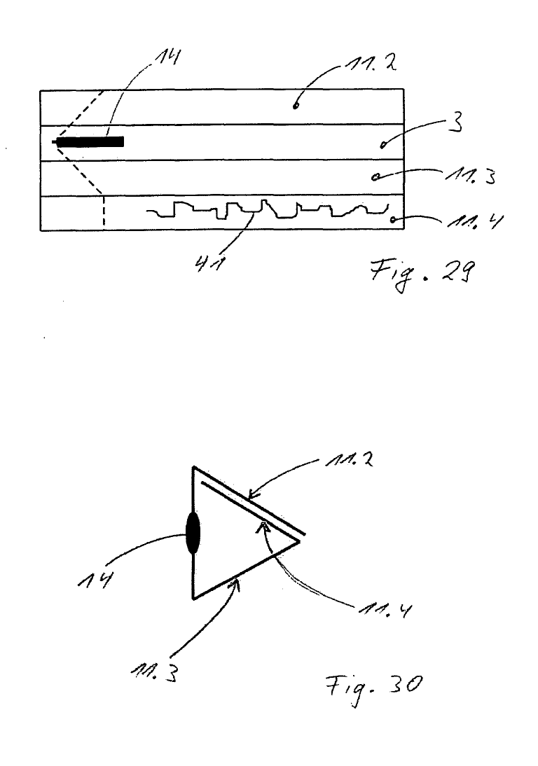

FIGS. 27 and 28 reveal a further preferred embodiment of a receptacle 38. The receptacle 38 has a groove 39 on each its sides.

In further embodiments, a groove 39 on the receptacle 38 may be formed to be circumferential.

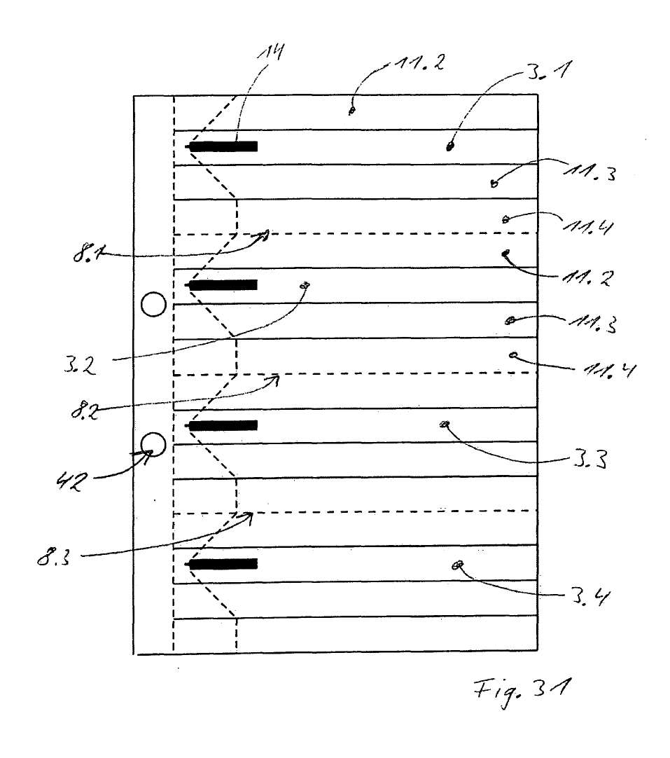

FIGS. 29 and 30 show a further embodiment of the writing space. Here, a further kink area 11.4 is associated to the kink areas 11.2 and 11.3. Through this folding area 11.4, the writing utensil area acquires further strengthening upon folding. Additionally, on at least one of the folding areas, a pressure-sensitive adhesive may be applied in order to join the two kink areas 11.2 and 11.4.

FIG. 31 shows a further embodiment of the writing space. In this instance, several writing spaces 3.1, 3.2, 3.3 and 3.4 are joined together in a row. At the perforations 8.1, 8.2 and 8.3, each of the single writing spaces may be detached before use as a writing utensil. By use of punch holes 42, such a combination of writing utensil areas may be filed, for example, in a ring file.

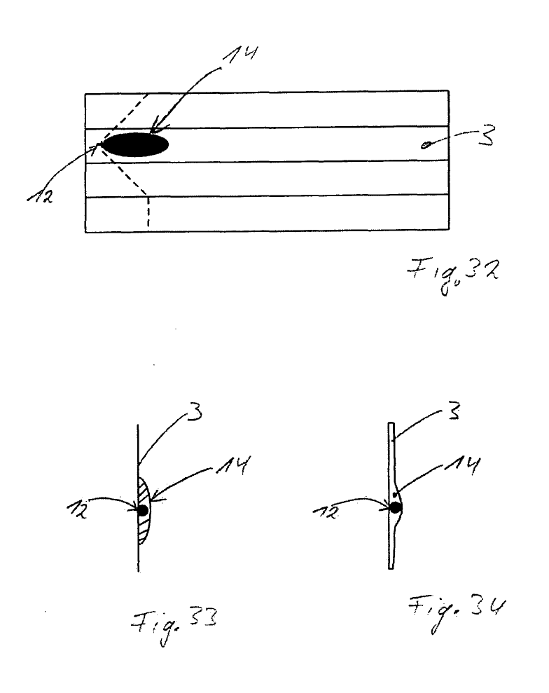

FIGS. 32 and 33 show a further embodiment of the writing space. In this instance, the lead 12 is fixed via a receptacle 14 consisting of hardened synthetic resin or the like.

FIG. 34 shows a further embodiment of the writing space. In this instance, the receptacle 14 is formed of a material equal to that of the writing space 3. Thus, the lead 12 may seamlessly be integrated into the writing space 3.

Paper may be inserted and fixed into both grooves 39 of the receptacle 38. The paper may be fixed in the grooves 39 by clamping, gluing and/or deforming of the grooves. In other respects, the receptacle 38 is analogous to the embodiments described above.

Further preferred embodiments may have the following features:

In a device for writing, drawing or the like with a writing medium 5 or 12, the material strips 3, 3.1 or 3.2 and a receptacle 14 form a flat strip.

In this instance, it shall be preferred that a tank 4 is integrated into a flat material strip 3, 3.1 or 3.2.

In this instance, it shall be preferred that the receptacle 14 is connected with the material strip 3.2.

In this instance, the receptacle 14 shall preferably consist of synthetic resin.

In this instance, the material strip 3, 3.1 or 3.2 shall have a kink area 11, 11.1, 11.2 or 11.3, whereas this material strip can be folded at a perforation 9 or 9.1 or a folding line 16.1 or 16.2.

In this instance, the material strip 3.2 shall have more than one kink area 11.2, 11.3.

In this instance, the tank 4 shall be implemented with a valve 6 to control the flow of writing fluid 5.

In this instance, the material strip 3 shall preferably have a perforation 10, by which a channel 7 can be opened in order to release the flow of ink.

In this instance, a lead 12 shall preferably be incorporated into the receptacle 14.

In this instance, the lead 12 shall preferably be a pencil lead or a color lead or a ball pen reservoir.

In this instance, the material strip 3, 3.1 or 3.2 shall preferably be connected to a note taking space 2, 2.1 or 2.2 by a detachable perforation 8, 8.1 or 8.2.

In this instance, the writing fluid 5 shall preferably be transparent and/or colorless and only take on color, or form a color contrast upon contact with air or a substance of the note taking space 2.

In this instance, the note taking area 2 shall preferably be covered with a resoluble pressure-sensitive adhesive on the side.

### LIST OF REFERENCE NUMBERS

1 paper
2 note taking space
3 writing utensil area/material strip
4 color tank
5 ink
6 valve
7 channel
8 perforation, detaching
9 perforation, folding
10 perforation, detaching
11 kink area
12 lead
13 front area
14 receptacle
15 opening
16 folding line
17 pin
18 opening
19 writing utensil
20 receptacle area
21 receptacle
22 welding cam
23 receptacle
24 clip
25 neck
26 collar
27 chamfer
28 receptacle
29 receptacle
30 upper part
31 lower part
32 cam
33 opening
34 receptacle
35 main body
36 kink wing
37 opening
38 receptacle
39 groove
40 area
42 punch holes
L length of receptacle
K length of paper strip
h height of receptacle

1-20. (canceled)

21. A method for the preparation of a paper writing utensil, comprising:
inserting a lead into a receptacle;
fixing the lead in the receptacle; and
connecting the receptacle to a paper.

22. The method of claim 21, wherein the lead is clamped in the receptacle.

23. The method of claim 21, wherein the lead is fixed to the receptacle by gluing.

24. The method of claim 21, wherein the lead is welded to the receptacle.

25. The method of claim 21, wherein the lead is thermally connected to the receptacle.

26. The method of claim 21, wherein the receptacle includes at least one groove into which the paper is inserted.

27. The method of claim 21, wherein the receptacle is glued to the paper.

28. The method of claim 21, wherein the paper and the receptacle are connected through thermal deformation.

29. A paper writing utensil produced according to the method of claim 21, the paper writing utensil comprising:
a paper strip;
a receptacle; and
a lead.

30. The paper writing utensil of claim 29, wherein the paper strip has at least one folding line.

31. The paper writing utensil of claim 29, further comprising:
a perforation for detaching the paper writing utensil from a note taking space.

32. The paper writing utensil of claim 31, wherein the note taking space includes a resoluble pressure-sensitive area.

33. The paper writing utensil of claim 29, further comprising:
at least one partially circumferential groove.

34. The paper writing utensil of claim 29, further comprising:
at least one fixing knob.

35. The paper writing utensil of claim 29, wherein the paper strip has at least one opening.

36. The paper writing utensil of claim 29, wherein the receptacle includes an opening for the lead.

37. The paper writing utensil of claim 36, wherein the receptacle has a height being maximally 2 mm higher than the paper strip.

38. The paper writing utensil of claim 36, wherein at least a part of the receptacle has grooves for receiving the paper strip.

39. The paper writing utensil of claim 36, further comprising:
fixing knobs.

40. The paper writing utensil of claim 38, wherein the length of the receptacle is maximally half the length of the paper strip.
